(19) United States
(12) Patent Application Publication
(10) Pub. No.: US 2003/0100254 A1
(43) Pub. Date: May 29, 2003

(54) Method of sterilizing mammal carcasses

(76) Inventor: Kazuo Iwai, Shiga-ken (JP)

Correspondence Address: BACON & THOMAS, PLLC, 625 SLATERS LANE, FOURTH FLOOR, ALEXANDRIA, VA, 22314

(21) Appl. No.: 10/291,473

(22) Filed: Nov. 12, 2002

(30) Foreign Application Priority Data
Nov. 29, 2001 (JP) 2001-364662

(51) Int. Cl. A22C 25/02; A22C 21/00; A22C 18/00; A22B 7/00

(52) U.S. Cl. 452/173

(57) ABSTRACT

A method of sterilizing mammal carcasses comprises the step of contacting the carcass with an aqueous hinokitiol solution in processing the carcass for a production of red meat as food. The aqueous hinokitiol solution is safe for a human body and enables to sterilize carcasses effectively without lowering quality of red meat as a final product obtained by processing the carcasses.

### BACKGROUND OF THE INVENTION

1. Field of the Invention

The present invention relates to a method of sterilizing mammal carcasses in processing the carcasses for production of red meat as food. More specifically, this invention relates to a method of sterilizing mammal carcasses which is safe for workers engaged in sterilization and enables to provide red meat as a final product without lowering its quality such as taste, texture and color.

2. Discussion of the Related Art

There has been reported news of food poisoning primarily resulting from meat every year. It is conceived that food poisoning resulting from meat is primarily caused by contamination of meat with various microorganisms such as pathogenic Escherichia coli O-157, Salmonella, Campylobacter, and Listeria.

In the United States of America, news that some hamburgers have been contaminated with the E. coli O-157 and that people have suffered from food poisoning by eating the hamburgers is still fresh in some people's memory. In addition to this news, in the year of 2000, twenty-one people died in the eastern part of the U.S.A. in the middle of winter because of food poisoning with Listeria.

Generally, livestock such as cows and pigs, which are sources for providing red meat, have bacteria such as Salmonella and pathogenic Escherichia coli, which cause food poisoning, in their internal organs such as intestinal canals. Accordingly, it is a customary practice to remove internal organs from the livestock (so-called “evisceration”) after binding the pharyngeal tube and the intestinal canal thereof in butchering (processing) the livestock so that the contents of the bowel may not leak out in the course of processing. However, even with such a cautious processing, a meager breakage of the intestinal canal of the livestock may allow the contents of the intestinal canal to leak out with the result that the contents may adhere to red meat which is a final product by processing the livestock.

Processing livestock such as cows to provide red meat comprises the steps as shown in FIG. 1. As shown in FIG. 1, after slaughtering, bleeding, and hide removal, livestock are subject to evisceration. Livestock after evisceration is generally called “carcass or carcasses”. After the evisceration, the carcass is cut into two parts with respect to the spine, and is subject to dressing. After the dressing, washing is performed to wash off blood and/or residue of internal organs or its equivalent from the carcass. After the washing, draining moisture and chilling are carried out in this order to distribute red meat, as a final product of the processing, to dealers and sellers of meat including meat processors. It should be noted that carcasses are stored in a chill storage for ripening in the chilling step. The period of chilling step for ripening varies depending on the kind of livestock. A swine carcass is stored in a chill storage for about 3 to 4 days, and a bovine carcass is stored in a chill storage for about one week.

In the above steps of the processing, if some bacteria remain on the carcass after washing, the bacteria may proliferate in the chilling and ripening steps following the washing step, which may cause food poisoning. Particularly, since Listeria keeps on surviving in a condition of a relatively low temperature, they may cause food poisoning if surviving the chilling and ripening steps.

In view of the above, there have been taken some measures such as washing with hot water in a temperature ranging from 60 to 80° C. in place of cold water, or spraying a bactericide after washing. There has been proposed use of chlorinated bactericides such as hypochlorous acid and sodium hypochlorite, and organic acids such as lactic acid and peracetic acid.

Hypochlorous acid is chemically unstable. In contact with a protein, hypochlorous acid has its concentration drastically decreased to about one hundredth relative to the concentration thereof before in contact with the protein. Accordingly, hypochlorous acid does not have sterilizing effect sustainability even if it exhibits sterilizing effect at the time of contacting. Furthermore, hypochlorous acid generates gaseous chlorine which is harmful for humans, at the time of dissolving. Accordingly, use of hypochlorous acid is restricted in the concentration of about 10 to about 200 ppm in view of safety measures for workers handling hypochlorous acid. However, with use of such a low concentration, satisfactory sterilizing effect cannot be ensured. It is true that some chlorinated bactericides, in which the chemical stability of hypochlorous acid is improved and emission of gaseous chlorine is suppressed by regulating pH thereof, provide a certain sterilizing effect. However, since such chlorinated bactericides undesirably bleach resultant red meat and may lower the commercial value thereof, they are not desirable in practical use.

Although lactic acid is not a harmful bactericide for humans, it may change the color of red meat into brown. Accordingly, use of lactic acid is less likely favored from a viewpoint that it lowers the commercial value of red meat. Particularly, in sales of meat of superior quality, color of meat is one of the primary criteria for judgement of quality. Lactic acid is less favored because of the above reason. Peracetic acid hardly causes bleaching action, and does not generate harmful gas. However, since peracetic acid has poor sterilizing effect compared to the above-mentioned bactericides, it is conceived that peracetic acid cannot exhibit desirable sterilizing effect against Escherichia coli O-157, which is a notorious bacteria to cause food poisoning these days.

In the processing of livestock to provide red meat, even if evisceration is carried out with utmost care so that the intestinal canal of the livestock may not be broken, and sufficient washing for sterilization of the carcasses is performed, the following phenomenon is unavoidable. Namely, during the chilling step for ripening in a chill storage for about one week, fungi such as Aspergillus floating in the air in the chill storage may adhere to the surface of the carcass under ripening and proliferate thereon with the result that mold may generate on the carcass surface. Further, even after the carcass is taken out of the chill storage after the chilling step is over, fungi may adhere to the carcass via workers on site or a work station where the step of cutting the carcass into blocks of red meat or the step of transporting and distribution is carried out. In view of these, it is desirable to sterilize the carcasses again after the washing step at an appropriate time until red meat as a final product of the processing is displayed on meat counters or showcases for sales to end consumers. However, unlike poultry meat, mammal meat or red meat loses its taste and savor when absorbing moisture. Accordingly, it is not desirable to wash red meat with water after cutting the carcass into blocks of meat. Further, it is a general practice to distribute red meat to meat counters as soon as possible after the ripening step is completed to eliminate or shorten a redundant storage period. Accordingly, there is no idea of using a chlorinated bactericide after the ripening step is completed. In view of this, it is conceived that peracetic acid has been the only bactericide in the prior art which is allowable to be used in sterilization after the ripening is completed. However, as mentioned above, since peracetic acid hardly exhibits sufficient sterilizing effect against pathogenic Escherichia coli O-157, sterilizing blocks of red meat is hardly carried out as a current practice in processing livestock (carcasses) into red meat.

### SUMMARY OF THE INVENTION

In view of the above, it is an object of this invention to provide a method of sterilizing mammal carcasses which is safe for workers engaged in sterilization and enables to sterilize mammal carcasses effectively without lowering quality and commercial value of red meat as a final product obtained by processing the carcasses.

According to an aspect of this invention, the method of sterilizing carcasses includes contacting the carcass with an aqueous hinokitiol solution.

### BRIEF DESCRIPTION OF THE DRAWINGS

FIG. 1 is a schematic flow diagram illustrating a typical procedure of a carcass for providing red meat;

FIG. 2 is a graph showing the measurement results of bacteriocidal activity of an aqueous hinokitiol solution against Escherichia coli present on the surface of red meat;

FIG. 3 is a graph showing the measurement results of bacteriocidal activity of an aqueous hinokitiol solution against Salmonella present on the surface of red meat;

FIG. 4 is a graph showing the measurement results of bacteriocidal activity of an aqueous hinokitiol solution against Listeria present on the surface of red meat;

FIG. 5 is a graph showing the measurement results of sterilizing effect sustainability of an aqueous hinokitiol solution.

### DETAILED DESCRIPTION OF THE INVENTION

The inventive method of sterilizing mammal carcasses in processing the carcass for production of red meat is characterized by a contact treatment with an aqueous hinokitiol solution.

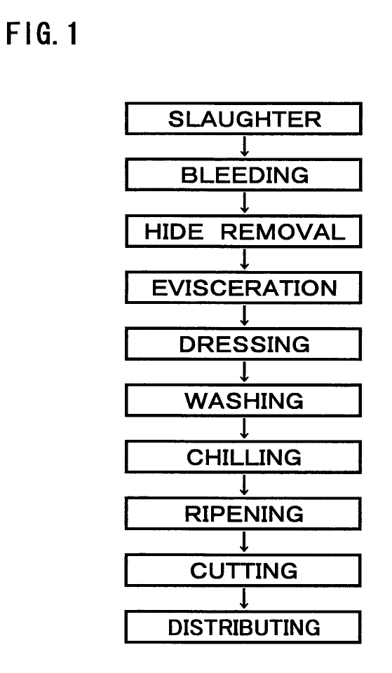

In FIG. 1 showing a typical procedure for providing red meat from a mammal carcass, the contact treatment is carried out at one or more stages selected from the following:

(1) after the washing step and before the chilling step,

(2) during the chilling step,

(3) after the ripening step and before the step of cutting the carcass into blocks of meat

(4) after the step of cutting the carcass into blocks of meat.

The mammal carcass to be applied in the present method is one of mammal livestock such as bovine, swine, sheep, horse, wild bore and deer except human, which can provide red meat as food.

The term “hinokitiol” is generally used as a generic name of β-thujaplicin, one isomer of thujaplicin. An aqueous hinokitiol solution used in the present invention may contain other isomers thereof, α-thujaplicin and γ-thujaplicin, besides β-thujaplicin.

The hinokitiol used in the present invention may be a naturally derived material or a synthetic material. The hinokitiol may be a purified product, or a composition containing hinokitiol. For example, an extract derived from natural plants can also be used. Further, a salt of hinokitiol can also be used.

The raw material plants of hinokitiol include, for example, white cedar leaf, Taiwanhinoki, Thujopsis dolabrata and the like. The extraction and purification of hinokitiol from raw material plants can be carried out by a known method.

The hinokitiol exhibits an excellent sterilizing effect against food poisoning pathogens such as pathogenic E. coli, Salmonella, Listeria, and Campylobactor, and fungi such as Aspergillus. Sterilizing effect of hinokitiol may be sustainable and inhibit generation of hinokitiol resistant bacteria. Hinokitiol has no toxicity or extremely low toxicity and is accepted as a food additive, and Shokuhin Eisei Ho (Japanese Food Sanitation Act) does not limit the allowable amount of hinokitiol. Accordingly there is no necessity for removing hinokitiol or the aqueous hinokitiol solution from the carcass after the contact treatment.

The kind of water as a solvent of the aqueous hinokitiol solution is not particularly limited. For example, tap water, distilled water, ion-exchanged water and the like can be used.

According to the present invention, the preferable concentration of hinokitiol in the aqueous hinokitiol solution is from 1 to 50000 ppm, more preferably from 10 to 5000 ppm, still more preferably from 25 to 1000 ppm, further still more preferably from 100 ppm to 1000 ppm.

An effective concentration of hinokitiol in the aqueous solution varies depending on the solubility of hinokitiol in water, size of a carcass to be applied, stage to be applied of the aqueous hinokitiol solution, and so on. Since hinokitiol dose not generalize a harmful gas, the solution containing hinokitiol in a high concentration may be used. Accordingly, an effective antimicrobial treatment may be achieved by use of small amount of aqueous hinokitiol solution having a high concentration of hinokitiol.

An aqueous hinokitiol solution used in the present invention may contain other component safe for human body besides hinokitiol and water as desired. Examples of the other components include extracts of aloe, green tea, low striped bamboo, and dokudami. These extracts may serve to enhance antimicrobial activity and contribute to elevate a solubility of hinokitiol in water.

When the aqueous hinokitiol solution contains other components, the resulting solution is preferably adjusted to pH of 4 to 11, more preferably from 6 to 8.

Now the stages at which the contact treatment is carried out will be described.

The term “after the washing step and before the chilling step” means a stage after blood which have been generated in the bleeding step and/or residues of internal organs which have been taken out in the evisceration step are washed off by showering water or hot (heated) water, and before the carcass is brought to the chilling step. Applying an aqueous hinokitiol solution to the carcass at this stage effectively keeps the sterilizing effect, thereby preventing proliferation of bacteria and generation of resistant bacteria during the chilling and ripening steps which follow the washing step. Application of an aqueous hinokitiol solution does not change color of resultant red meat, unlike a chlorinated bactericide. Accordingly, applying an aqueous hinokitiol solution at this stage ensures maintaining the fresh color of red meat inherent thereto which makes consumers feel tasty and fresh with sufficient ripening being ensured.

The term “during the chilling step” means a stage of ripening the carcass in a chill storage. The period of ripening varies depending on the kind of livestock to be processed. In case of processing bovine carcasses, the carcasses are stored in a chill storage for ripening for about one week. If fungi or other bacteria exists in the air inside the chill storage, such fungi or other bacteria may adhere on the surfaces of the carcasses during the chilling period, thereby proliferating the fungi or other bacteria. Even if the interior of the chill storage is periodically sterilized, entering of the workers in and out of the chill storage may allow fungi or other bacteria floating in the air outside of the chill storage to intrude into the chill storage accompanied by the entering, thereby resulting in adhesion of such fungi or other bacteria onto the carcass surfaces. Accordingly, sterilization in the chilling step is significant in preventing the carcasses under ripening from being contaminated with newly-intruded fungi or other bacteria, as well as sterilizing the remainder of bacteria which have survived the sterilization in the washing step.

Sterilization by an aqueous hinokitiol solution before and/or after the step of cutting the carcass into blocks of meat after the ripening step has the following advantage. Specifically, the cutting step after the ripening step is closer in time to the distributing step of distributing red meat to end consumers or the cooking step that red meat is actually cooked. Use of a bactericide which may leave odor peculiar to the bactericide or change the color of red meat is not preferable at this stage before and/or after the cutting step. Further, use of water for sterilization at this stage is not preferable because moisture remaining on red meat may deteriorate the taste and texture of the red meat. Further, the following situation also has to be considered. In the case where sterilization before the chilling step is insufficient, it is highly likely that bacteria may survive the chilling step. In a worst case, bacteria, which can survive in a condition of a relatively low temperature such as Listeria, may proliferate in the chilling step. Accordingly, use of sterilizing agent which has a strong sterilizing action before and/or after the cutting step is desired. Application of an aqueous hinokitiol solution at this stage is advantageous because the aqueous hinokitiol solution is safe in use and does not necessitate post-treatment after contacting a carcass with the aqueous hinokitiol solution. Furthermore, the aqueous hinokitiol solution exhibits sufficient sterilizing effect with less application of moisture to the carcass (or block of red meat). Accordingly, desirable sterilization can be performed with use of the aqueous hinokitiol solution without adversely affecting taste, savor, and texture of red meat inherent thereto.

According to the present invention, the contact treatment is carried out by spraying, showering, atomizing or applying an aqueous hinoktiol solution, or rubbing with an aqueous hinokitiol solution, or immersing a carcass in an aqueous hinokitiol solution. A preferable embodiment is showering or spraying because it can sterilize plural carcasses together to improve treatment efficiency and lessen absorption of moisture by the carcass in the course of the contact treatment. The contact treatment by spraying or showering includes, for example, the following embodiments: an embodiment of passing a carcass under shower of an aqueous hinokitiol solution; an embodiment of spraying an aqueous hinokitiol solution over the entire carcass; and an embodiment in which carcasses are maintained for a certain period in a chamber filled with a mist of an aqueous hinokitiol solution.

In the case where the contact treatment with an aqueous hinokitiol solution is carried out during the chilling step, it is a preferable embodiment that carcasses are stored in a chill storage which is filled with a mist of an aqueous hinokitiol solution for a predetermined time while the carcasses are stored. Filling the chill storage with a mist of an aqueous hinokitiol solution during the chilling step may contribute to sterilize not only bacteria and fungi present on the surface of carcasses but also fungi floating in the air in the storage.

In case of spraying an aqueous hinokitiol solution, a mixture of ethyl alcohol with aqueous hinokitiol solution is more preferably used than the aqueous hinokitiol solution alone. The ethyl alcohol in the mixture serves to lengthen the floating period of hinokitiol in the air and to kill fungi floating in the air in the storage effectively. Therefore, spraying aqueous hinokitiol solution with ethyl alcohol prevents viable fungi from adhering on the carcasses and exhibits more effective antimicrobial activity than the aqueous hinokitiol solution alone.

A usable concentration of the ethyl alcohol in the above-mentioned embodiment is from 60 to 80% by volume, but it is not limited to. The ethyl alcohol having such concentration may assist an aqueous hinokitiol solution in diffusing easier and wider in the chill storage. The preferable mix ratio of ethyl alcohol to the aqueous hinokitiol solution is from 2:1 to 1:2, but it is not limited to.

In more preferable embodiment, the mixture is atomized or sprayed by means of a high-pressure inert gas, for example using an atomizer “Shut Noxious (trademark)” produced by Sinko Sangyo Kabusikigaisha. Using this atomizer, the mixture is sprayed at a gas pressure of 3 to 10 kgf/cm² to fill a chill storage with a mist of hinokitiol solution easily. A method of disinfection comprising the step of spraying alcohol using the pressurized carbon dioxide is disclosed in U.S. Pat. No. 6,043,287 (the contents of which is incorporated herein by reference).

As the inert gas, nitrogen gas and/or carbon dioxide gas is preferably used. Carbon dioxide is more preferably used because carbon dioxide may inhibit growth of microorganism. Therefore spraying the aqueous hinokitiol solution by means of high-pressure carbon dioxide may improve bacteriocidal activity of the contact treatment with the solution.

A usable temperature of the aqueous hinokitiol solution varies depending on which stage the contact treatment is carried out. According to the present invention, where the contact treatment is carried out after the washing step and before the chilling step, the solution having a temperature of 0 to 70° C. is preferably used. Where the contact treatment is carried out during the chilling step or after the ripening step, the solution having a temperature of 0 to 15° C. is preferably used, a solution cooled down to 10° C. or less is more preferably used. When the meat blocks cut from the carcass are contacted with an aqueous hinokitiol solution, the solution having a temperature of 0 to 15° C. is preferably used, a solution cooled down to 10° C. or less is more preferably used.

The period of contacting with an aqueous hinokitiol solution varies depending upon embodiments of the contact treatment. In the case of immersing the carcass in the solution, the time period of immersion is preferably within 1 minute, more preferably within 30 seconds, still more preferably within 20 seconds. While such a period of immersion suffices for sterilizing carcasses, more than 1 minute of immersion allows the carcass to absorb moisture and thereby deteriorating quality of the finally obtained red meat, particularly its taste and texture. However in the case of spraying or applying the aqueous hinokitiol solution, or rubbing with the solution, the contact time period is not particularly limited because it will not have a big effect on absorption of moisture.

### EXAMPLES

The present invention will be described in further detail by means of the following examples without intending to limit the scope of the present invention thereto.

### Example 1 Bacteriocidal Activity of Aqueous Hinokitiol Solution

An aqueous hinokitiol solution with pH 6 having compositions shown in Table 1 was prepared. The bacteriocidal activity of an aqueous hinokitiol solution on Escherichia coli, Salmonella, and Listeria was measured using the prepared solution by the following method.

TABLE 1

| | | |
|---|---|---|
| Purified water | 10000 | g |
| Hinokitiol | 2.00 | g |
| Aloe extract | 1.5 | g |
| Green tea extract | 1.2 | g |
| Low striped bamboo extract | 0.3 | g |
| Dokudami extract | 0.3 | g |

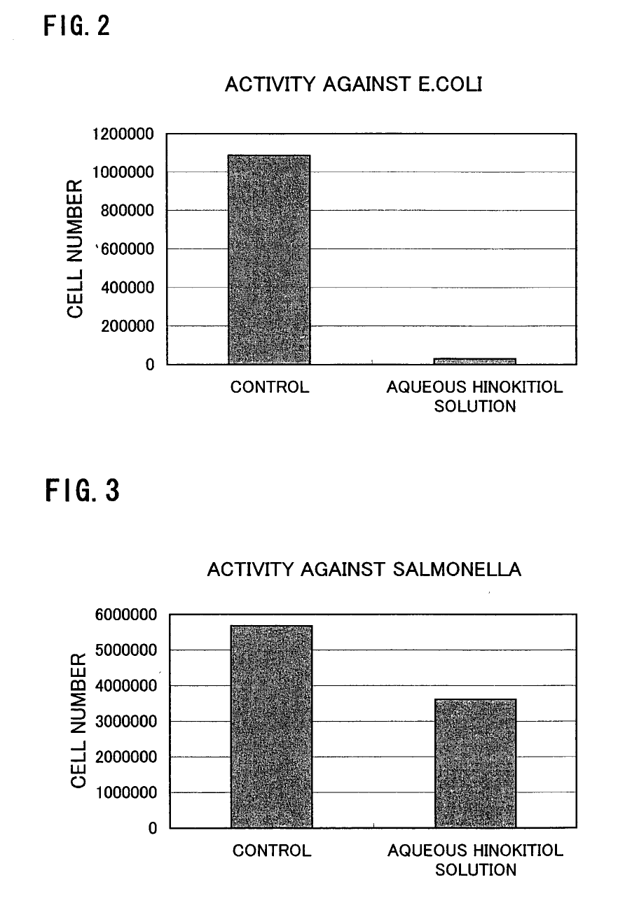

Ten 300 g lumps of beef as red meat were immersed and kept in a solution containing 10⁷ cells of E. coli per ml at room temperature for 24 hours. And then the ten lumps of red meat were divided into two groups (hinokitiol treatment group and control group). Beef lumps of the hinokitiol treatment group were sprayed with the prepared aqueous hinokitiol solution. One hour later a surface area having 3 cm in length and 3 cm in width of the each lump was wiped with a wiping paper “fukifukicheck” sold by Eiken Kizai. Thus E. coli present on the surface area was adhered to the paper and then transferred to culture medium (DIFCO medium) by pressing the paper onto the medium. The transferred E. coli was incubated on the culture medium at 42° C. for 24 hours. After incubation, the viable cell number from each lump was counted and the average of the group was calculated. Beef lumps of the control group were treated in the same manner as those of the hinokitiol treatment group except they were not sprayed with the aqueous hinokitiol solution. The measurement results are shown in FIG. 2.

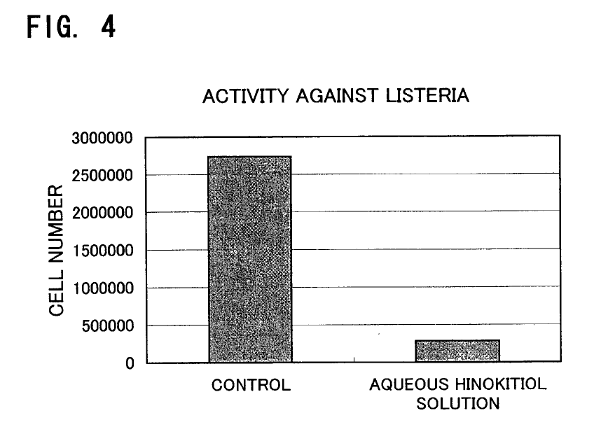

The tests for Salmonella (ATCC25923) and Listeria (FMK1256) were conducted respectively in the same manner as the test for E. coli. The result of the test for Salmonella is shown in FIG. 3 and the result for Listeria is shown in FIG. 4.

As shown in FIGS. 2, 3 and 4, every hinokitiol treatment group exhibits excellent bacteriocidal activity.

### Example 2 Verifying Sterilizing Effect Sustainability of Aqueous Hinokitiol Solution

In this experiment, a lump of beef as red meat of about 300 g was put in a sterilized bag, and the beef lump was inoculated with Escherichia coli by applying a solution containing 10⁶ cells of E. coli per ml with such an amount that 0.1 ml of the solution was applied per 1 g of the beef lump. Thus, a group (B+) which was inoculated with E. coli was prepared.

Next, another lump of beef as red meat of substantially the same weight as the inoculated group (B+) was put in a sterilized bag, and the beef lump was applied with a buffer solution of phosphoric acid in place of a solution containing E. coli with such an amount that 1 ml of the buffer solution was applied per 1 g of the beef lump. Thus, a control group (B−) was prepared.

The openings of both of the sterilized bags each containing the inoculated group (B+) and the control group (B−) were sealably closed by a rubber band, and kept at 4° C. for 18 hours.

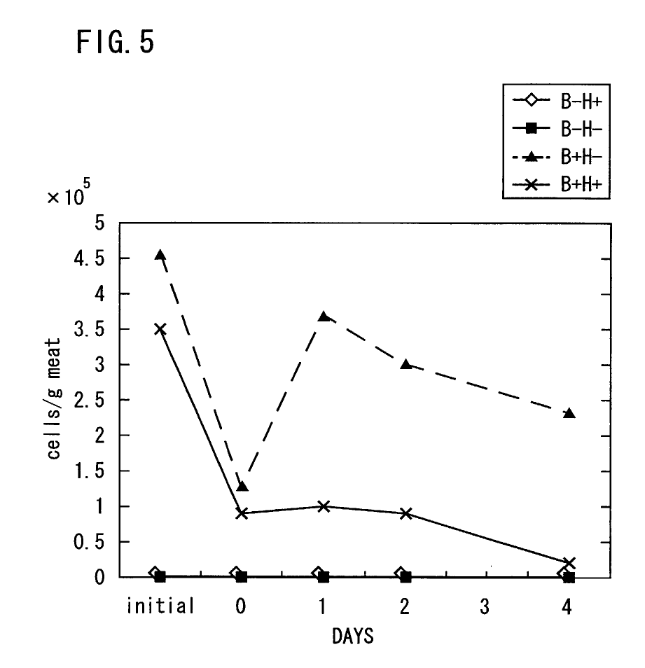

After the above period lapsed, 25 g was sliced off each from the beef lumps of the inoculated group (B+) and the control group (B−) at the initial time (see FIG. 5) of the experiment, and the viable cell number was counted with respect to these two initial sample pieces by implementing the same viable cell count method as performed with respect to sample cut pieces obtained upon lapse of 1 day, 2 days, and 4 days from 0 time, which is described below.

Then, after slicing off 25 g of the cut piece from the inoculated group (B+), the remaining lump of the inoculated group (B+) and the control group (B−) were each cut into two parts to obtain sample chunks (B+H+), (B−H+) and (B+H−), (B−H−). The sample chunks (B+H+), (B−H+) were obtained by immersing the two chunks of the inoculated group (B+) and the control group (B−) in the aqueous hinokitiol solution essentially consisting of water and hinokitiol (concentration of hinokitiol: 125 ppm) for 15 seconds with such an amount that 1 ml of the aqueous hinokitiol solution was applied per 1 g of the beef chunk. After draining moisture, each beef chunk was put in a newly-prepared sterilized bag. On the other hand, the sample chunks (B+H−), (B−H−) were prepared by treating another chunk of beef each from the inoculated group (B+) and the control group (B−) in the same manner as the sample chunks (B+H+), (B−H+) except that these two beef chunks were each immersed in sterilized tap water in place of the aqueous hinokitiol solution. When observing the sample chunks (B+H+), (B−H+), (B+H−), and (B−H−) with the unaided eyes, there has not been found any difference between the sample chunks (B+H+), (B−H+) and the sample chunks (B+H−), (B−H−) in its outer appearance (particularly, color) at the processed time (0 time in FIG. 5).

Next, 25 g of beef piece was sliced off each from the sample chunks (B+H+), (B−H+) and the sample chunks (B+H−), (B−H−) each time upon lapse of 1 day, 2 days, and 4 days from the processed time (0 time) after letting the sample chunks stand, and the viable cell number was counted with respect to each sample piece by implementing the following method. It should be noted that each sample piece was cut in such a manner that the ratio of fat to brawn thereof was set at 3 to 7.

Specifically, each cut piece of 25 g was put in a sterilized bag, 225 ml of butterfield phosphate buffer solution was added to each sample piece, and the contents of the bag was subjected to homogenization by a stomacher device. After the homogenization, the supernatant of the homogenized solution was diluted as 1,000 times thin as the initial concentration before dilution, and 0.1 ml of the diluted solution was applied on a flat medium for cultivating E. coli for 24 hours. The number of colony after cultivation was counted with respect to each medium each time upon lapse of 1 day, 2 days, and 4 days from the processed time (0 time).

The measurement results are shown in FIG. 5.

As shown in FIG. 5, at the time of processing (0 time), the number of E. coli was decreased compared to the initial time with respect to the sample pieces including the sample piece (B+H+) and the sample piece (B+H−). However, in the sample piece (B+H−), growth of E. coli appeared when one day passed from 0 time. In contrast, in the sample piece (B+H+), there has been hardly seen growth of E. coli even with respect to the interior of the sample piece where the solution was not directly applied. Thus, it was verified that the sterilizing effect of the aqueous hinokitiol solution was maintained with respect to the sample piece (B+H+).

As a result of the measurement results of the experiment, it is obvious that applying the aqueous hinokitiol solution to carcasses in the ripening step and to blocks of red meat as a final product to be distributed to end consumers is effective in sterilizing E. coli.

### Example 3 Bacteriocidal Activity of Aqueous Hinokitiol Solution Against Fungi

The minimum inhibitory concentration (MIC) of an aqueous hinokitiol solution against Aspergillus nigar IFO4414 was determined by the agar plate dilution method.

An aqueous hinokitiol solution having a concentration of 0.1% was diluted as 10 times, 20 times, 50 times and 100 times thin as the initial concentration before dilution (concentrations of the diluted solutions; 0.01, 0.005, 0.002, and 0.001% by volume). Potatodextrose culture plate media containing the respective diluted solutions were prepared and inoculated with Aspergillus nigar IFO4414 respectively, followed by incubation at 30° C. for 7 days. After incubation, the agar plate media were examined as to whether a colony grew on each medium or not. The results are shown in Table 2. In Table 2, “+” denotes that fungi was grown and “−” denotes that fungi not grown.

TABLE 2

| | | | | |
|---|---|---|---|---|
| Concentration (%) | 0.001 | 0.002 | 0.005 | 0.01 |
| Growth of fungi | + | + | + | − |

As seen from Table 2, at least 0.01% of aqueous hinokitiol solution can inhibit growth of fungi.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of sterilizing mammal carcasses comprising contacting the carcass with an aqueous hinokitiol solution in processing carcass for production of red meat.

2. The method according to claim 1, wherein the contacting is carried out after washing the carcass and prior to chilling the carcass.

3. The method according to claim 1, wherein the contacting is carried out while storing the carcass in a chill storage.

4. The method according to claim 1, wherein the contacting is carried out after ripening the carcass.

5. The method according to claim 1, wherein the contacting is carried out after cutting the carcass into blocks of red meat.

6. The method according to claim 1, wherein the contacting is carried out by at least one selected from the group consisting of applying the solution, spraying the solution, rubbing the solution and immersing the carcass in the solution.

7. The method according to claim 3, wherein the chill storage is filled with a mist of the aqueous hinokitiol solution.

8. The method according to claim 3, wherein the contacting is carried out by spraying a mixture of the aqueous hinokitiol solution and alcohol in the chill storage.

9. The method according to claim 8, wherein the mixture is sprayed by means of a high-pressure inert gas.

10. The method according to claim 9, wherein the inert gas is one selected from the group consisting of nitrogen gas and carbon dioxide gas.

11. The method according to claim 1, wherein the aqueous hinokitiol solution contains hinokitiol ranging in concentration from 1 to 50000 ppm.

12. The method according to claim 1, wherein the aqueous hinokitiol solution has a pH of 4 to 11.

13. The method according to claim 2, wherein the aqueous hinokitiol solution has a temperature of 0 to 70° C.

14. A method according to claim 3, wherein the aqueous hinokitiol solution has a temperature of 0 to 15° C.

15. A method according to claim 4, wherein the aqueous hinokitiol solution has a temperature of 0 to 15° C.

16. A method according to claim 5, wherein the aqueous hinokitiol solution has a temperature of 0 to 15° C.

17. A method according to claim 1, wherein the carcass is one of mammal livestock selected from the group consisting of bovine, swine, sheep, wild bore, and deer.

18. A method according to claim 1, wherein the aqueous hinokitiol solution comprises hinokitiol, water, aloe extract, green tea extract, low striped bamboo extract, and dokudami extract.
